(19) United States
(12) Patent Application Publication
(10) Pub. No.: US 2024/0404291 A1
(43) Pub. Date: Dec. 5, 2024

(54) SYSTEM FOR MONITORING THE POSITION OF A VEHICLE ON A RACETRACK

(71) Applicant: FOGLDN LTD, London (GB)

(72) Inventors: Joshua Ward, Colchester (GB); Matous Kundrik, Colchester (GB); Philip Lawrence, Colchester (GB)

(73) Assignee: FOGLDN LTD, London (GB)

(21) Appl. No.: 18/259,266

(22) PCT Filed: Dec. 23, 2021
(86) PCT No.: PCT/GB2021/053419

§ 371 Date: Jun. 23, 2023

(30) Foreign Application Priority Data
Dec. 23, 2020 (GB) 2020545.6

(51) Int. Cl. G06V 20/54; G01S 17/89; G06T 7/70; G06T 17/00

(52) U.S. Cl. CPC G06V 20/54; G01S 17/89; G06T 7/70; G06T 17/00; G06V 2201/07

(57) ABSTRACT

A racetrack monitoring system for monitoring at least one region of a racetrack to detect the position of the vehicle on the racetrack includes a sensor assembly, which when in use is fixed in position relative to the racetrack and captures data representative of the location in a three-dimensional space of objects within a field of view of the sensor assembly. The system further includes a processing means that is configured to process the captured data to identify objects corresponding to the vehicle and to generate a model of the vehicle in a model dimensional space. The processing means is configured to determine the position of the vehicle model relative to a pre-determined point or region of a racetrack that is in the field of view of the sensor assembly.

### CROSS REFERENCE TO RELATED APPLICATIONS

The present application claims the priority benefits of International Patent Application No. PCT/GB2021/053419, filed on Dec. 23, 2021, and claims benefit of GB 2020545.6, filed on Dec. 23, 2020, both of which are hereby incorporated herein by reference in their entireties.

### FIELD OF THE INVENTION

This invention relates to improvements in systems for use in monitoring the position of a vehicle on a race circuit, and in particular the invention is suitable for monitoring of infringements of track limits.

### BACKGROUND OF THE INVENTION

Motor racing is a popular pastime, which can be both fun and extremely competitive. It can also be a dangerous sport, and to ensure the safety of the drivers and also any spectators or trackside workers most race tracks and race events will have a strict set of rules that are enforced during use of the circuit. One such rule is the track limit rule, sometimes called the track margin limit. In the UK, the Motor Sports Association (MSA), have specific rules defining limits for the track and sanctions that may be imposed if the driver breaches the limits. For example, the rules state that ‘a driver will be judged to have left the track if any wheel of the car either goes beyond the outer edge of any kerb or goes beyond the white line where there is no kerb’. In the MSA track circuit racing guidance notes go on to give some example image to show what is and is not considered to be within track limits, as shown in FIG. 1 of the accompanying drawings The vehicle in FIG. 1(a) is considered not to have breached the limits, the one shown in FIG. 1(b) is considered to have breached track limits. This is a tougher restriction than that applied by other racing governing bodies such as the FIA, where a driver is ok as long as at least one wheel remains on the track and has not crossed the white line.

At present, the enforcement of track limits is mostly achieved by placing a marshal at each corner of the track who is tasked with observing each car as it drives through the corner. If the marshal observes a car breaching the limit, they will report this to the track controller or race organiser. They may then decide what if any penalty may be appropriate.

At more well-funded tracks, and certainly in many well-funded motor sport series, electronic devices may alternatively be installed at one or more of the corners. These include pressure sensitive pads that may be embedded into the side of the track and which issue an electronic alert is a vehicle runs onto or crosses the pad. This works especially well under the MSA rules, where any one of the wheels may hit the sensor and indicate a breach, but works less well under the more generous previous rules. These sensors are costly to install, are easily damaged, and are not suited to flexible track layouts where the location of the boundary may be regularly moved by repainting the white lines. The position of the sensor to enforce the MSA rules will not work for enforcing FIA rules for example.

As an alternative to pressure pads, some circuits have installed timing loops which are buried in the ground outside of a track limit and detect the presence of a timing transponder that is fitted to a vehicle. These are widely used for timing at small race venues such as kart tracks when placed perpendicular to a track at a start/finish line. A suitable affordable system is the MYLAPS TranX140 System from Mylaps Zuiderhoutlaan 4, 2012 PJ Haarlem, The Netherlands. The transponder constantly transmits a digital signal containing a unique ID for the vehicle. When a vehicle crosses the timing loop of wire buried in the track the signal is detected by the timing loop. Use of this technology for track limits is generally only suitable for use in the better funded racing series such as formula 1® due to the need to dig up and resurface the track at each area where the limit is to be enforced and to provide a network of cabling for sending the signals from the loops back to the track or race director who may work from a control tower.

In other situations, a camera may be installed at the corner to take video of the vehicle passing and feedback to an observer who can monitor any corner of the track for a convenient location such as a control tower. Recordings of the video may be used after an infringement of the track limits has occurred to provide evidence of the infringement. A common problem is that the view of the vehicle from the camera may sometimes be insufficiently clear if obscured, for example, by a following or preceding vehicle on the track. A large number of cameras are needed, and still require human analysis of the cars to detect a breach. As such they are no more reliable than having marshals physically located around the track.

Accurately detecting breaches of the track limit is very important. Most track day events will impose a penalty for a breach, and the same is true for most competitive race events. On a track day an incorrectly flagged breach could cost a driver some track time, which for a paying customer will be a considerable annoyance. A track with a poor reputation for incorrectly enforcing limits could lose business. In a worse case, a time penalty imposed due to an incorrectly flagged breach of the track limits after a race has finished may be the deciding factor in who is awarded the race win or even who may win the race season. For an event of high public interest, such as a race in the FIA Formula 1 Series, the amount of money that could be lost from an incorrect decision can be enormous. Whenever a human is involved in making these decisions, there remains a risk of an error.

In addition to detecting breaches of track limits, the ability to determine how close a vehicle is coming to a target point in a track may be useful for driver training or for providing entertaining statistics to a viewer of a race. Getting close to a perfect position at an apex, and being able to repeat that lap after lap, are the mark of a true world class driver.

### SUMMARY OF THE INVENTION

Aspects of the present invention provide a racetrack monitoring system for monitoring at least one region of a racetrack to detect the position of the vehicle on the racetrack. According to one aspect of the present invention, the system comprising:
a sensor assembly which in use is fixed in position relative to the racetrack and captures data representative of the location in a three-dimensional space of objects within
a field of view of the sensor assembly, and
a processing means,
in which the processing means is configured to process the captured data to identify objects corresponding to vehicles and to generate a model of the vehicle in a model dimensional space,
and in which the processing means is configured to determine the position of the vehicle model relative to a pre-determined point or region of a racetrack that is in the field of view of the sensor assembly.

In a most preferred arrangement, the predetermined point or area is a track boundary and the processing means is adapted to determine from the position of the vehicle model whether the vehicle or part of the vehicle has is on the side of the boundary outside of the track.

The processing means may be adapted to generate an alert when the model indicates that the vehicle or part of the vehicle has crossed the boundary. This may comprise a signal that has a value indicating that a vehicle has crossed the boundary and optionally the time.

The system may include a transmitter that transmits data to a central station, and the central station may include a receiver that is configured to receive the signals. This data may comprise the alert signal.

The transmitter and receiver may operate across a wireless network, such as the cellular telephone network, or they may be hardwired together so that data is transmitted over a physical cable or fibre. The signal may be transmitted along a cable as an optical or electrical signal.

The sensor assembly may capture data representative of the vehicle and also the region of track and the processing means may generate a model of the track from the captured data.

Alternatively, the information captured from the sensor assembly may be used to model the vehicle and determine the relative location of the model in a defined space, combining this with separate information about the location of the track within the defined space to determine the position of the vehicle.

The system may include a digital camera which captures a digital image of the vehicle if determined that the vehicle is outside track limits, and may capture a short video clip of the vehicle either side of the time at which the breach occurs. The image or video may be stored in an area of electronic memory. The system may include a transmitter that transmits the captured digital image to a central location. This may be the same transmitter that will transmit alert signals where that is a function of the processing means. It may transmit over a wireless or a wired (including optical fibre) network. The image and alert may be transmitted together, or may be tagged to show that they are associated, for instance using a time stamp.

The processing means may generate a two-dimensional model of the vehicle and the location relative to the track limit. This may be a bird's eye view of the vehicle from above. Alternatively, the processing means may develop a three-dimensional model of the vehicle, for example from a view point corresponding to a user defined point on the track.

The processing means may comprise a digital signal processor, an area of electronic memory, at least one data input for receiving data the sensor array, and at least one data output for outputting a trigger signal in the event a breach of limits has occurred.

Most preferably the sensor assembly comprises a LiDAR sensor which captures a point cloud of data, each point corresponding to a different location in space within a field of view of the sensor. For each position, a value may be generated indicative of the distance to an object at that point. Representing these values on a colour scale allows a two-dimensional image to be generated in which near and far objects are identified by the colour in the image.

Lidar sensors employ a well-known technique for measuring the distance to an object in which the object is illuminated using a beam of light emitted by a laser light. This light will be reflected from an object back to the sensor. By measuring the return time of the reflected light, the distance can be determined. By taking many measurements at points across a two-dimensional grid, a two-dimensional image can be produced in which the distance can be encoded as a colour value in the image, giving the image both XY and Z information. The model may be generated from the point cloud by appropriate image processing techniques.

The LiDAR sensor may generate a data set comprising multiple horizontal rows of points, each row corresponding to a known height above the surface of the racetrack or to a known azimuth angle from a negative azimuth to capture reflections from the track to a positive azimuth to capture reflections from a vehicle above the track.

The point cloud, and in turn the 3D model, may have a resolution in the model space of no less than a few cm, and preferably less than 1 cm, in order to determine with accuracy, the relative position of the vehicle on (or off) the track.

The point cloud of data from the LIDAR sensor will also indicate the location of a track boundary if that boundary is demarcated physically from the adjacent track, e.g., as raised kerb or a sharp contrast in colour.

A suitable LIDAR sensor assembly may comprise a laser light source that generates a narrow beam of light, a scanner that can vary the direction in which the beam is emitted, a photodetector that detects reflected portions of the light beam, and a processing device that processes the output from the photodetector to generate the set of captured image data.

In an alternative, which may also be used in the system of the present invention, the LIDAR sensor assembly may comprise a flash-type lidar in which a diverse beam is emitted that covers the entire field of view and in which a grid of photodetectors is provided, each generating one point of the captured data.

The sensor and the processing means may be located at the side of track, so that they are in close proximity and connected physically. Providing a processing means at the location of the sensor enables the modelling to be done locally and reduces the amount of data that is to be transmitted to the remote station. Alternatively, the processing means may be located at a central location with only the sensor at the trackside.

Where the sensor and processing means are spaced apart, a transmitter may be provided that transmits captured data from the sensor to a central processing unit, and the processing unit may be provided with a receiver. The transmitter and receiver may operate wirelessly, or may be hardwired together.

Where the processing means is located local to the sensor assembly, a transmitter may be provided to transmit a signal indicative of a breach to a remote station or otherwise indicate the position of a vehicle on the track. In that case the raw captured data output from the sensor assembly does not need to be transmitted.

The sensor may have a field of view whereby when in a position of use it will capture an image of a scene that includes the region of the track that is being monitored and any vehicle on the track or off to one side or either side of the track.

For example, the sensor may capture a region of a track corresponding to the inside of a complete corner, or a region containing an apex of the corner. It may capture an inner edge of a corner or an outer edge or both within the same scene. It may capture an exit to a corner, or an entrance or both.

The sensor and optionally the processing means may be mounted on a support, such as a pole, that is located at the side of the track. The sensor assembly may be fixed in location during use. This may be a permanent or temporary installation, the later allowing simple alternations to the field of view of the sensor assembly as the track limits are changed or to monitor other areas of the track. The support may hold the sensor assembly to one side of the track, or may hold it above the track. As long as the sensor assembly has a clear view of the region of track that is being monitored the choice of location is unrestricted.

The system may include a power source, such as a battery, to power the sensor assembly and optionally the processing means where located at the same location as the sensor assembly. Including a battery makes the system highly portable, allowing it to be used in locations around a track that do not have a mains power supply available and removing the need for long power cables to be trailed out to the sensor assembly.

The system may include a user interface which enables a user to input the track limits. This may be a graphical user interface, such as a touchscreen display. It may be a personal computer or a handheld electronic device such as a smartphone or tablet.

Where the user interface includes a display, the system in use may present a view of the track on the display, and the interface may enable the user to mark an outline of the track limits. Once marked, the processing means may determine the location of the marked outline in the 3D model space, for example by fusing the image with a point set captured from the LiDAR sensor assembly. Computer program instructions may be provided which cases a 2D or 3D image of the scene viewed by the sensor assembly to be presented to a user which they can mark up. With a touchscreen marking could be done using a finger or stylus pressed on the screen but a mouse or other input device could be used within the scope of the invention, either with a touch sensitive screen or without.

The system may include a camera that captures an image of scene, the image overlapping at least in part with the field of view of the sensor assembly. Thus, any vehicle identified by the sensor assembly will appear in the field of the view of the camera.

The system may include a trigger which causes the camera to capture an image of the vehicle when a breach of track limits is detected. This may be used by a race steward to identify the specific vehicle and to provide further proof of a breach for use in any appeal against an imposed penalty.

The system may comprise a plurality of sensor assemblies, each located at a different point around a track. Each may generate a respective stream of captured data sets for analysis. A camera may be associated with each sensor assembly. Having multiple sensor assemblies allows a corresponding number of points or regions of track to be monitored. For a race circuit with 10 corners, 10 sensor assemblies may be provided with each one positioned where it can monitor a respective corner of the track.

Where there is a plurality of sensor assemblies, each may be associated with a respective processing means. Alternatively, all the sensor assemblies may feed captured data to a shared processing means.

Alternatively, the system may stream captured sensor data from each sensor assembly to the remote station where the modelling is generated. The central station may comprise a processing unit, which may form a part of a portable computer or laptop. The system may include a transmitter that transmits data to a central station, and the central station may include a receiver that is configured to receive the signals.

The system may transmit in real time, and generate a model in real time. There may be a delay between a vehicle passing a point on the track and a model being generated, depending on the amount of processing performed and the processing speed of the processing unit. A small delay is perfectly acceptable in most cases, allowing a race director to make a reasonably swift decision based on any alerts that are generated.

In addition to, or alternatively to, determining if a track limit has been breached and outputting a trigger, the system may generate a signal indicative of how close the vehicle has come to a predetermined point or region of a racetrack. For instance, it may indicate how close a vehicle came to an apex of a corner. This information could be used as a training aid for a driver, or displayed to a spectator watching a race.

According to a second aspect, the invention provides a method of monitoring at least one region of a racetrack to detect the position of the vehicle on the racetrack, the method comprising:
Using a sensor assembly, capturing data representative of the location of a vehicle relative to a track,
generating a model of the vehicle from the captured data,
and determining the position of the vehicle relative to a predetermined point or area of the track using the model.

The sensor assembly may be fixed in position relative to the racetrack using a suitable support. The method may capture data as a point cloud from a LIDAR system and may be oriented such that the field of view of the LIDAR includes both the vehicle and the region of the racetrack.

These and other objects, advantages and features of the invention will become apparent upon review of the following specification in conjunction with the drawings.

### BRIEF DESCRIPTION OF THE DRAWINGS

There will now be described, by way of example only, two embodiments of the present invention with reference to and as illustrated in the accompanying drawings of which:

FIGS. 1(a) and (b) show a vehicle that has not breached and a vehicle that has breached a track limit,

FIG. 2 is an overview of a first embodiment of a system for monitoring the position of a vehicle on a race track;

FIG. 3 is a more detailed schematic representation of the remote part of the system of FIG. 2;

FIG. 4 shows an example of an image formed from a point cloud set output from the 3D LiDAR assembly used in the system;

FIG. 5 shows an image from a digital camera of the same scene that is viewed by the sensor assembly of FIG. 4;

FIG. 6 shows a 3D model generated from the point cloud overlaid on a 3D model of the racetrack;

FIG. 7 shows how a user can mark the position of a track boundary on a touchscreen;

FIG. 8 shows an alternative embodiment of a system in which the processing means is provided at a central part and shared by the sensor assemblies of multiple remote parts;

FIG. 9 shows the remote part supported by a pole that can be fixed in position near a corner or other part of a racetrack that is to be monitored giving the sensor assembly a good view of the track; and

FIG. 10 is a flow diagram showing the method steps performed by the exemplary system of FIG. 1 or of FIG. 8 when in use.

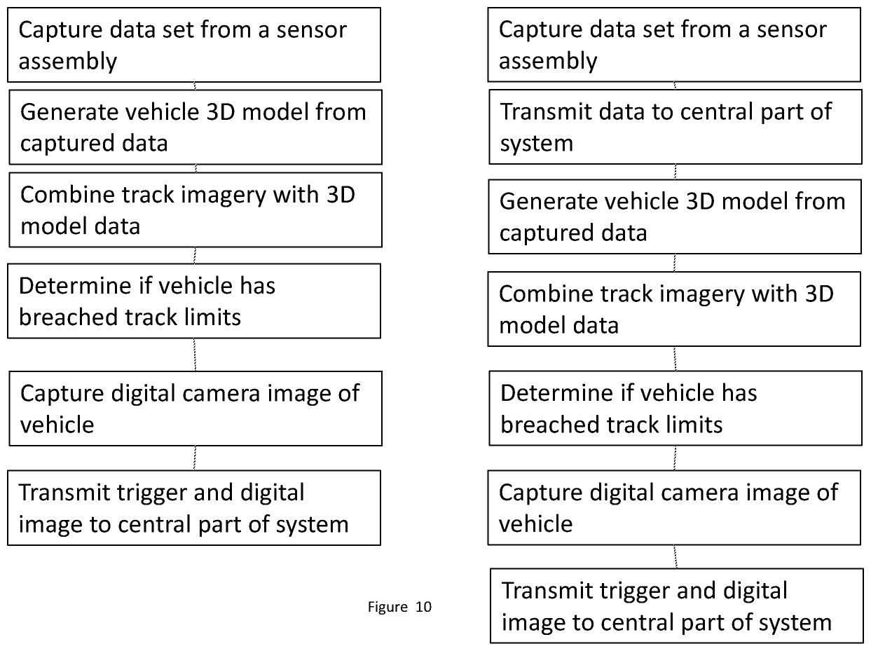

### DESCRIPTION OF THE PREFERRED EMBODIMENTS

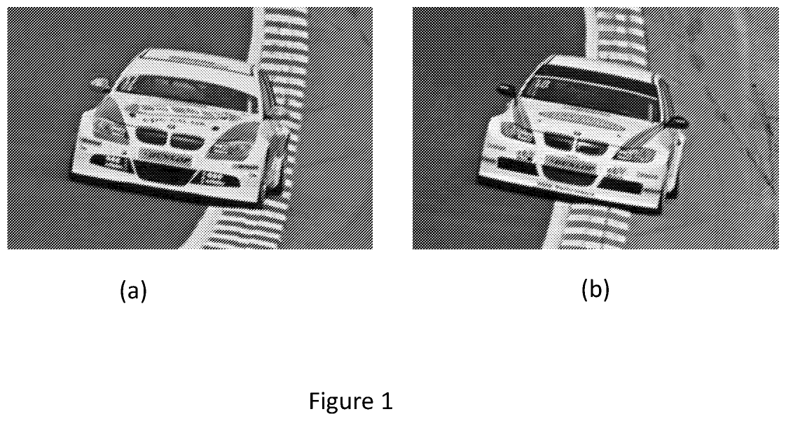

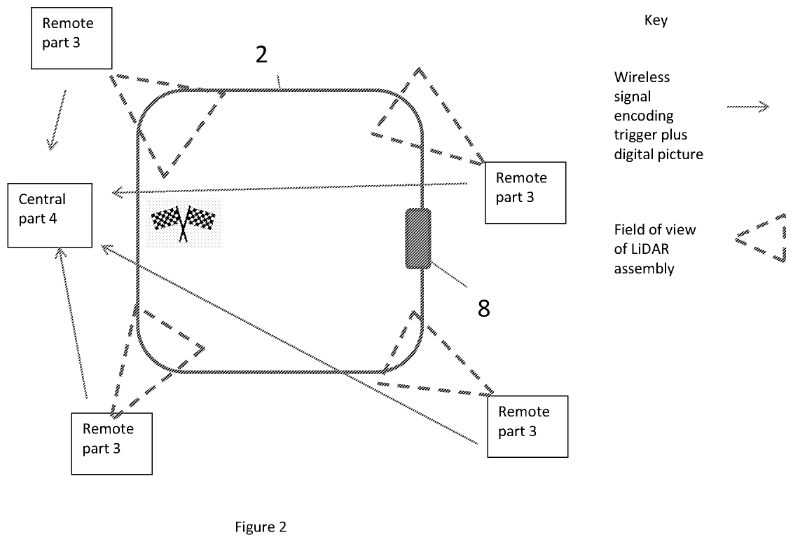

FIG. 2 shows a first exemplary system 1 in accordance with the present invention installed at a simple loop shaped racetrack 2 with four corners. The system 1 has two main parts; a remote part 3 that is to be located in use adjacent a part of a racetrack that is to be monitored, and a central part 4 which is located with a race director. In this example, four identical remote parts are provided and the central part 4 may be located anywhere as it is in communication with the remote parts 3 through a wireless communication network. The arrows in FIG. 1 show the flow of signals across the wireless network from the remote parts 3 to the central part 4. By central we do not mean it has to be located at the physical centre of a track.

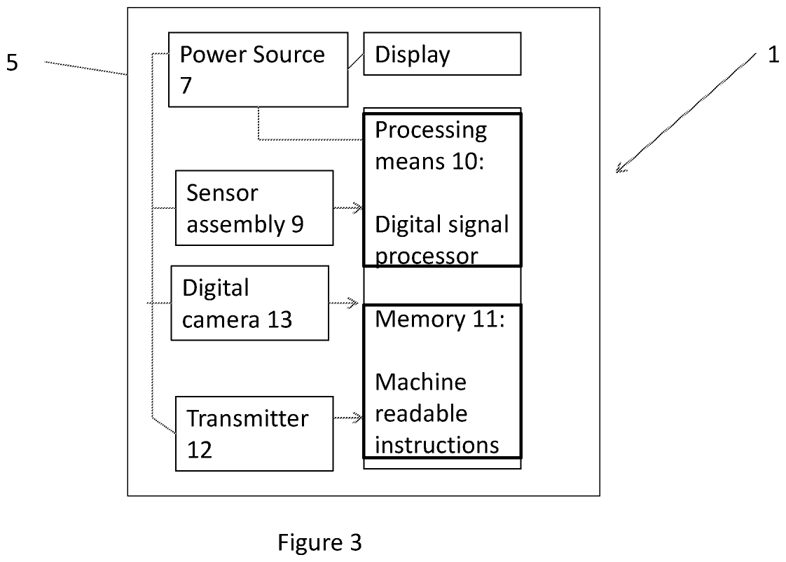

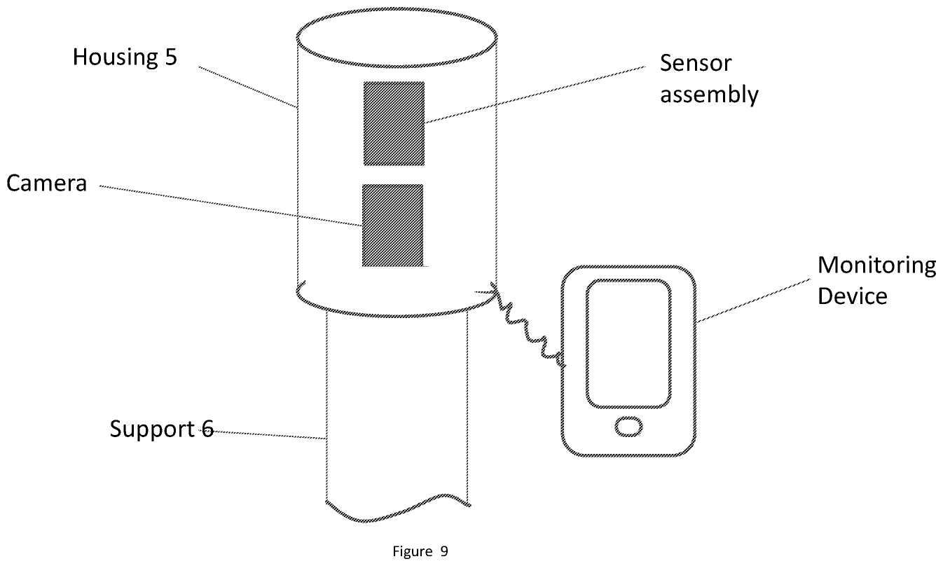

As shown in FIGS. 3 and 9, the remote part 3 comprises a housing 5, in the form of a weather proof sealed box supported by a support 6 such as a pole at a height above the level of the racetrack. The housing 5 accommodates various pieces of electronic equipment including a power source 7 such as a battery that is used to power the equipment. The battery is not essential, and if a mains power source is present at the remote location this may be used to power the device. Where mains power is provided, the remote part may include a power source that includes a transformer to convert the mains voltage down to a lower voltage that is suitable for powering the electronic circuitry.

In this example, each remote part 3 is located at a corner on a racetrack. The system 1 monitors vehicles 8 passing the corner and as will be described is able to alert a race director via the central part of any infringement of track limits.

FIG. 3 shows schematically the remote part 3 of FIG. 2. This comprises a sensor assembly 9, a processing means 10, a memory 11 and a wireless transmitter 12. Each part receives power from the battery 7. The sensor assembly 9 comprises a LIDAR sensor array that is fixed to the housing such that the sensor assembly captures images of a scene in front of the housing. The field of view of the sensor assembly in this example includes an outer apex of a corner.

The LIDAR sensor array 9 comprises a single light source and a two-dimensional grid of photodetectors. A driver for the light source causes the source to emit a series of very short light pulses, which are focused by a lens to image a wide field of view. A second lens captures reflected light and focuses this back onto the photodetectors of the array. The value of each photodetector is then read out in sync with the pulses to generate a sequence of images, each made up of a so-called point cloud of data. Each point represents a position in a 3D space of a reflective surface.

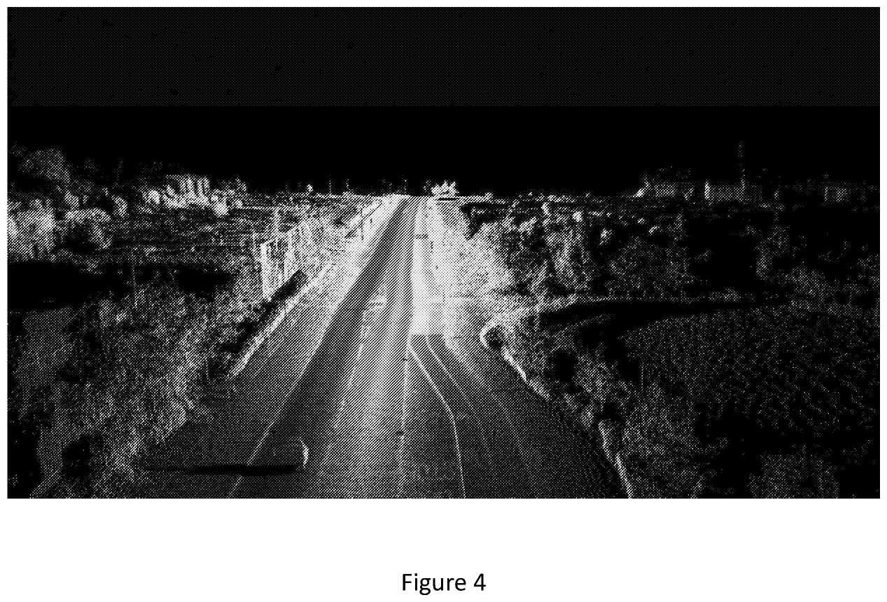

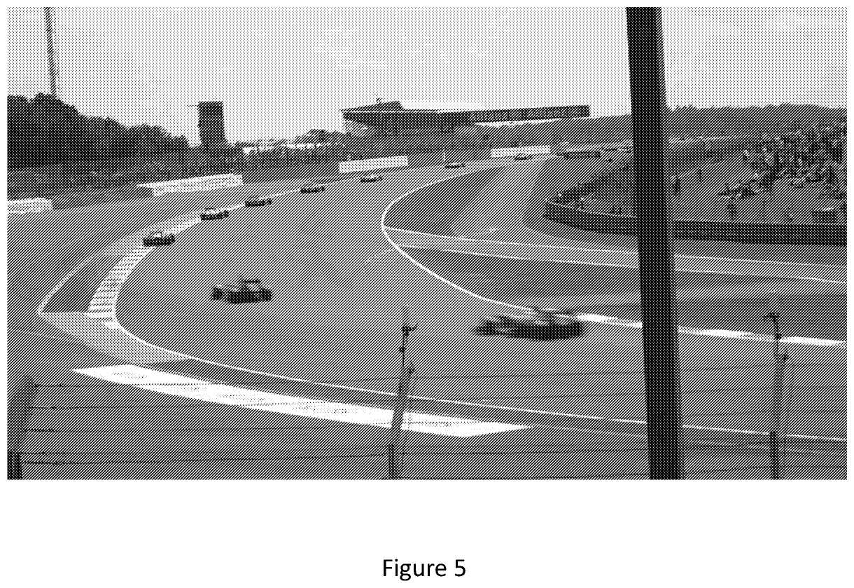

In use the LIDAR sensor array 9 captures a sequence of images of the type shown in FIG. 4, an image from a LiDAR system produced by Velodyne Inc, one of several manufacturers of suitable LiDAR systems. The sensor array scans from left to right at several different elevations, producing a set of points arrange in rows where the height of each row represents a height in the scene. FIG. 5 shows a corresponding image of the same scene captured by a digital camera. Each point in the image has a colour indicative of the range of an object in the field of view at that point. As can be seen, the image captures information on the range of a vehicle on the track and also the range of features of the track itself. Close objects are coloured red, and more distant are coloured blue.

The processing means 10 comprises a digital signal processor that is connected over a data bus to an area of permanent memory and to an area of random access (RAM) memory 11. The processor has read/write access to the RAM which allows the processor to store the data from the sensor array temporarily in the memory prior to and during processing of the data. The permanent memory stores program instructions which can be read by the processor and which cause the processor to carry out a set of operations.

FIG. 9 illustrates the key steps carried out by the processing means when in use. The point cloud data captured by the sensor array is fed into an input of the digital signal processor and is processed to generate a model (such as a 3D or 2D bird eye view) of a vehicle that is present in the scene that is viewed by the sensor array. The modelling may use a range of image processing techniques to identify points that correspond to parts of a vehicle. One suitable technique is disclosed in the paper titled “Mapping Digital Image texture onto 3D model from LIDAR data”, authored by Chunmei Hu et al, published in the International Archives of the Photogrammetry, Remote sensing and Spatial Information Sciences Journal., Vol. XXXVII, part B5, Beijing 2008.

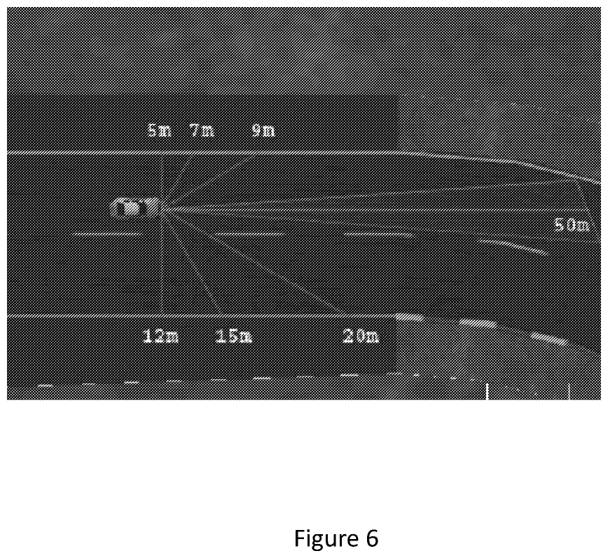

In addition to generating the 3D model of the vehicle 8 seen in the captured image, the processing means 10 generates a model of the track region in the same image space as the vehicle model. An example of a model of the vehicle on a track is shown in FIG. 6 of the accompanying drawings. The model may be generated by detecting track boundaries in the captured point sets in the same manner as ADAS systems might detect lane boundaries on a highway. An exemplary technique is taught in the conference paper “Lane Recognition Using on-vehicle LiDAR”, Takashi Ogawa et al, present to the IEEE in January 2006, DOI: 10.1109/IVS.2006.1689864. Of course, unlike a vehicle mounted system which has to continuously identify changing lane boundaries as the vehicle travels along a highway, the system of this invention only has to identify the location of boundaries once and store this in a memory.

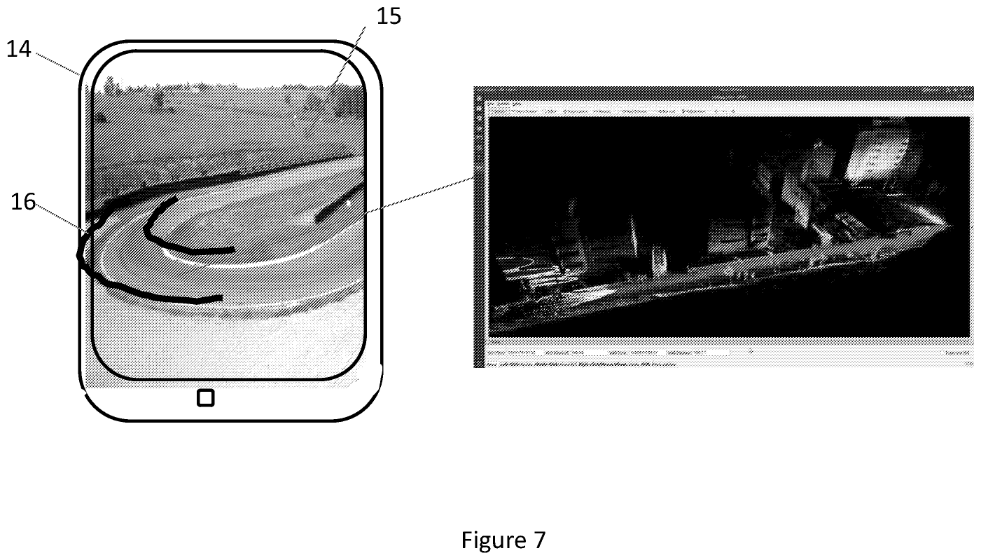

Using the two models; the 3D vehicle model and the 3D track model, the position of the vehicle on the race track is determined by the processing means. FIG. 7 shows the model of a vehicle and a portion of track.

Having determined the position of the vehicle relative to the track, the processing means 10 is configured to determine if the vehicle 8 has infringed any track boundary limits. This requires the processing means to have knowledge both of the location of a track boundary and also the rules or how much of a vehicle must have crossed the boundary to breach the limits.

The remote part also includes a digital camera 13. This is arranged so that the camera 13 captures an image that matches, or contains within it, the field of view of the sensor. FIG. 5 shows an exemplary captured image. The camera 13 and sensor assembly 9 may be stacked side by side or one above the other, so they take images from substantially the same view point. The images captured by the digital camera 13 may be fused with the point cloud data by the digital image processor in order to build the model of any vehicles seen by the sensor assembly 9. This may provide greater accuracy compared with building the model from the LIDAR captured data alone, in particular making it easier to correlate track locations in the LIDAR data with the camera image, this otherwise being difficult if regions of the track are marked by coloured lines which are flush with the adjacent track as these may be invisible to LIDAR. An exemplary technique for detecting track boundaries from LIDAR point data without using a camera is taught in the paper titled “Real time Road Lane detection in Urban Areas Using LiDAR Data”, Jiyoung Jung etc al, Journal of Electronic 2018, 7, 276; doi: 10:2290/electronics7110276.

The track boundary location is fed into the system through a graphical user interface or display 14. This is shown in FIG. 7. This comprises in this example a touchscreen on which the processing means 10 displays an image 15 of the track from the point of view of the sensor array. A user may then mark on the image the location of a track boundary 16. The processing means 10 combines the marked boundary with data captured from the sensor array and/or the camera image to determine the location of the marked boundary in the 3D model space. It is within the scope of this invention for the processing means to automatically detect the track boundary if information that uniquely identifies the boundary is available to the system, e.g., the colour of the track boundary line. In that case, the digital signal processor may identify elongate features of that colour in the images and flag these to a user as possible track boundaries.

The rules may also be manually entered through the graphical user interface. For example, a user may be asked to select between one or more different rules that are prestored in the memory. A simple rule would be that the entire vehicle has to have crossed a track boundary to have breached the track limits. Once selected, the processing means will apply those rules when analysing the model for a breach of the track limits.

The processing means 10 repeats the digital signal processing of the output of the sensor array 9 for every captured set of points, detecting vehicles 8 that appear in the captured data sets and determining if any track limits have been breached. The rate at which new data sets is produced should be set high enough to ensure any short duration breach of track limits is captured. If a limit has been breached, an alert is generated by the processing means 10. This is fed to the transmitter 12 associated with the remote part, and sent to a receiver of the central part 4. The signal received at the remote part 4 is fed into an application which may be executed on a personal computer or handheld electronic device such as a smart phone or tablet. The race director can then determine how to respond to any breaches.

When an alert is generated indicating that a limit has been breached, an image is also captured by the camera 13. This is stored in the memory and transmitted to the central part as supporting evidence of the breach.

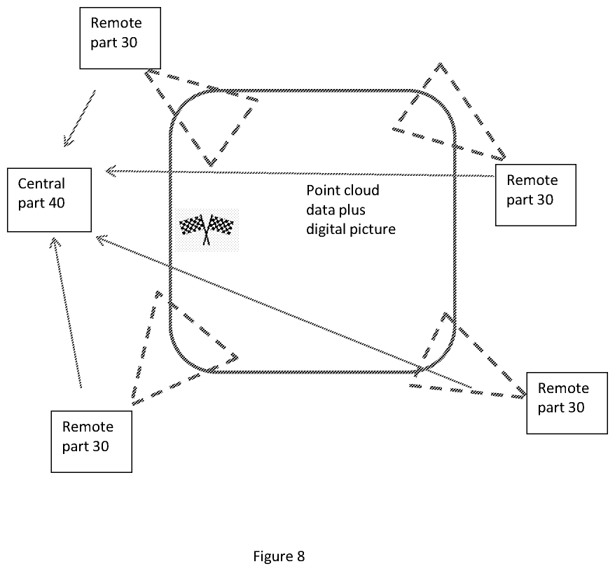

In a modification, shown in FIG. 8, a simpler form of remote part 30 is provided whereby the processing means is located at the central part 40. Instead of generating and analysing the model at the remote part the system may capture day with the model being generated and analysed at the central location. The processing means at the remote location may be much simpler and needs only to send the captured image data to the central location rather than an alert. FIG. 8 shows the flow of that information across the wireless network.

The skilled person will understand that the invention may be implemented in a number of ways that differ from the exemplary embodiments. In particular, different types of sensors could be used to capture the data used to generate the vehicle model. For instance, a stereo camera could be used to capture image data from two different viewpoints which is combined to generate an image which has the required depth information. The system may include multiple remote parts, each placed at a different location around a racetrack to capture breaches of track limits as those different locations. They may be placed where they can observe corners, or straight parts of the track, indeed anywhere that a driver may gain an advantage by breaching the track limits or where it would unsafe to leave the track.

Changes and modifications in the specifically-described embodiments may be carried out without departing from the principles of the present invention, which is intended to be limited only by the scope of the appended claims as interpreted according to the principles of patent law including the doctrine of equivalents.

1. A racetrack monitoring system for monitoring at least one region of a racetrack to detect position of a vehicle on the racetrack, the system comprising:
a sensor assembly that, when in use, is fixed in a position relative to the racetrack and configured to capture data representative of a relative location in a three-dimensional space of objects within a field of view of the sensor assembly, and
a processing means configured to process the captured data to identify one or more objects corresponding to the vehicle and to generate a model of the vehicle in a model dimensional space, wherein the processing means is configured to determine a position of the vehicle model relative to a pre-determined point, area or region of the racetrack that is in the field of view of the sensor assembly.

2. The system according to claim 1, wherein the predetermined point or area is a track boundary, and wherein the processing means is adapted to determine from the position of the vehicle model whether the vehicle or part of the vehicle is beyond the boundary.

3. The system according to claim 2, wherein the processing means is adapted to generate an alert when the model indicates that the vehicle or part of the vehicle crossed the boundary.

4. The system according to claim 1, wherein the sensor assembly captures data representative of the vehicle and also the region of track, and the processing means generates a model of the track from the captured data.

5. The system according to claim 1, wherein the data captured by the sensor assembly is used by the processing means to model the vehicle, determine the relative location of the model in a defined space, and to combine the model with separate information about the location of the track within the defined space to determine the position of the vehicle.

6. The system according to claim 1 further comprising a digital camera configured to capture a digital image of the vehicle if determined that the vehicle is outside track limits.

7. The system according to claim 1, wherein the sensor assembly comprises a LiDAR sensor that is configured to capture a point cloud of data, each point corresponding to a different location in space within a field of view of the sensor.

8. The system according to claim 1, wherein the processing means is located local to the sensor assembly, and wherein the processing means includes a transmitter configured to transmit a signal indicative of the location of the vehicle to a central station.

9. The system according to claim 1, wherein the sensor assembly is mounted on a support at a location alongside the racetrack.

10. A method of monitoring at least one region of a racetrack to detect a position of a vehicle on the racetrack, the method comprising:
using a sensor assembly to capture data representative of a location of the vehicle relative to the track;
generating a model of the vehicle from the captured data; and
determining the position of the vehicle relative to a predetermined point or area of the track using the model.
